(19) United States
(12) Patent Application Publication
(10) Pub. No.: US 2017/0369764 A1
(43) Pub. Date: Dec. 28, 2017

(54) FORMULATIONS AND METHODS FOR MINERAL SCALE REMOVAL

(71) Applicant: FQE CHEMICALS INC., Calgary (CA)

(72) Inventor: Douglas J. Mason, Sugar Land, TX (US)

(21) Appl. No.: 15/194,939

(22) Filed: Jun. 28, 2016

(51) Int. Cl. C09K 8/532

(52) U.S. Cl. CPC C09K 8/532

(57) ABSTRACT

A composition is provided for sulfate scale removal, said composition comprising one or more chelants and one or more accelerants, wherein said accelerants serve to occupy reactive sites of cations of the sulfate scale. The composition is preferably provided wherein said one or more chelants comprise a mixture of two or more polyaminopolycarboxylic acids. The composition if further preferably provided, wherein said one or more accelerants promote rapid complexation of cations of the sulphate scale. The composition is further still preferably provided, wherein said one or more accelerants comprise substances that have a smaller molecule size than that of said one or more chelants.

### FIELD OF THE INVENTION

The present invention relates to compositions and methods for removal of mineral scales.

### BACKGROUND OF THE INVENTION

Mineral scale formation in surface and subsurface oil and gas production equipment is recognized as major operational problem in oil and gas production. Mineral scale build up is also an issue in other industries, such as pulp and paper making. Group II metal ions, with the exception of perhaps magnesium, can all form sparingly soluble scales. Scale deposits have been identified as complexes of calcium such as carbonate, oxalate, sulfate, silicate; aluminum such as silicate, hydroxide, phosphate; barium such as chloride, carbonate, sulfate and various other alkaline earth and transitional metal salts. The most common scales are: calcium carbonate; sulfate salts of calcium, strontium and barium; and sodium chloride.

In the oil and gas industry, sulfate scales are formed when subsurface formation water is mixed with injected sea water. Many subterranean waters contain alkaline earth metal cations, such as barium, strontium, calcium and magnesium. Sea water has high concentration of SO₄²⁻ and formation waters, with high concentrations of Ca²⁺, Ba²⁺ and Sr²⁺. The injection of seawater into oilfield reservoirs is necessary to maintain reservoir pressure and improve secondary recovery. When two incompatible waters are mixed such as seawater and formation water and interact chemically, a precipitate or scale is formed. Two waters are called incompatible if they interact chemically and precipitate minerals when mixed. Mixing of these waters, therefore, could cause precipitation of CaSO₄, BaSO₄ and SrSO₄.

Three common mechanisms for scale formation on onshore and offshore oil field system are:

1) Decrease in pressure and/or increase in temperature of a water, leading to a reduction in the solubility of the salt (most commonly these lead to precipitation of carbonate scales, such as CaCO₃).
2) Mixing of two incompatible water, most commonly formation water rich in cations such as barium, calcium and/or strontium, mixing with sulfate rich seawater, leading to the precipitation of sulfate scales, such as BaSO₄.
3) Water evaporation, resulting in the salt concentration increasing above the solubility limit and leading to salt precipitation. This may occur in high pressure, high temperature gas wells where a dry gas stream may mix with a low grade brine stream resulting in dehydration and most commonly the precipitation of NaCl.

Scale may prevent effective heat transfer, interfere with fluid flow, facilitate corrosive processes, or harbor bacteria. Scale is an expensive problem in many industrial water systems, in production systems for oil and gas, in pulp and paper mill systems, and in other systems, causing delays and shutdowns for cleaning and removal.

Barium and strontium sulfate scale deposits present a unique and particularly intractable problem. Of all the scales in the oil industry, barium sulfate scales are the most easily precipitated due to the very low solubility (2.3 mg/L). In oil and gas production operations, deposition of calcium, barium and strontium sulfate scales are especially problematic as these species are unreactive to typical chemical processes used for scale dissolution.

Scales and deposits can be formed to such an extent that the permeability of the formation is impaired resulting in lower flow rates, higher pump pressures, and ultimately abandonment of the well.

Another problem associated with the formation of barium and strontium sulfate scales is that radium, another member of the alkaline earth group of metals, tends to be deposited at the same time so that the equipment becomes radioactive, and may eventually have to become unusable for safety reasons alone.

Scale treatments include scale inhibition, sulfate ion removal and scale removal. Scale inhibitors try to prevent or delay scale formation at substoichiometric levels in solution. Nucleation inhibitors disrupt and redissolve the scale protocrystals formed due to supersaturation and prevent deposition. Crystal growth inhibitors adsorb on or interact with the crystal growth sites (growing edges or spirals) and retard the crystal growth by “poisoning” the growth of scale nuclei. Some chemicals chelate or tie up the reactants in a soluble form. If inhibitors cannot be used, scale formation can be prevented by removing the sulfate ions from seawater by approaches like membrane distillation, nanofiltration, and reverse osmosis.

However, if scale formation cannot be prevented, or if the strategy to prevent its formation fails, scale deposits are removed either with mechanical means like milling, jetting, ultrasound or chemical means like sequestration with a chelating agent. Mechanical means can be effective in the well bore, but are not of much use, if deposits are in the formation.

Chemical removal treatments are considerably less expensive than mechanical methods and effective for scale removal from the formation. Barium sulfate scale is insoluble in most mineral acids like hydrochloric acid, nitric acid, etc.

Hence the only way to dissolve the barite scale is by using complex organic acids called chelating agents or chelants. These chelating agents are ethylamine molecules having multiple carboxylic acid arms which can pick up barium molecules from solid state and bring them into the solution. Common chelating agents include diethylene triamine pentaacetic acid (DTPA) and ethylene diamine tetraacetic acid (EDTA). These formulations will remove scale deposits, however, the amount of scale removed is small and the rate of dissolution is slow. Additionally, as the cations in question are almost non-complexible, the use of chelants results in excess chelant that is disposed essentially wasted.

Prior art attempts at dissolving barium sulfate include utilizing boiling sulfuric acid. This is impractical and dangerous for dissolving downhole barium sulfate. Another method for removing barium sulfate is to fracture it with extremely high pressure. However, this process is quite costly in that it requires special equipment and extra manpower, and results in lengthy well downtimes. Another prior art process for removing barium sulfate is to perforate the scale, which is not very effective. In some instances, when scales present too much of a problem, the well is simply abandoned and a new well is drilled when scales present too much of a problem. Obviously, this is a very costly solution.

U.S. Pat. No. 5,068,042 (Hen, 1991): utilizes sulfate scale (barium, strontium, radium) dissolution by compositions comprising an aqueous solution of an aminopolycarboxylic acid (APCA) or its salt, and a second component which is diethylenetriaminepenta(methylenephosphonic) acid (DTPMP) or its salt, or aminotri(methylenephosphonic) acid (ATMP), or its salt. U.S. Pat. No. 5,762,821 (Tate, 1998) and U.S. Pat. No. 5,685,918 (Tate, 1997): teaches scale deposits removal by contact with an aqueous solvent of a polyaminocarboxylic acid chelant (EDTA) in an alkaline environment produced by the addition of a potassium base (KOH), a hydroxycarboxylic acid synergist, a wetting agent, and optionally a sodium base. U.S. Pat. No. 6,494,218 (Zaid et al., 2002) teaches scale dissolver compositions comprise an aqueous dispersion which includes a salt of a chelating agent, a carbonate, a base, and an organophosphorus compounds, carboxylic acids and mixtures thereof. The chelating agent is a salt of EDTA. The dissolver composition is heated to a temperature of from 100-170 F., and then contacted with the scale. U.S. Pat. No. 7,470,330 B2 (Keatch, 2008) discloses a method for removing scale from surfaces such as barium sulfate, strontium sulfate, and radium sulfate using aqueous solution of EDTA and potassium carbonate. U.S. Pat. No. 7,343,978 (John et al., 2008) proposes a scale dissolver fluid for dissolving scale (barite) in a subterranean hydrocarbon-bearing formation which comprises an aqueous solution of EDTA and a salt of EDTA. Surfactant is used to reduce the viscosity of the fluid. U.S. Pat. No. 4,973,201 (Paul et al., 1990) discloses a method for decontamination by applying an aqueous chemical composition comprising a chelating agent (EDTA or DTPA) and a synergist (oxalate or monocarboxylic acid anion such as salicylate), which increases solubility of sulfates in an aqueous solution. WO1990011972 A1 (Morris and Paul, 1990) teaches that alkaline earth metal scales, especially barium sulfate scale deposits are removed with a composition comprising an aqueous alkaline solution having a pH of about 11 to 13, of a polyaminopolycarboxylic acid, EDTA or DTPA and a catalyst or synergist comprising, oxalate, thiosulfate, nitriloacetate or monocarboxylic acid anions. U.S. Pat. No. 4,190,462 (De Jong et al., 1980) teaches barium sulfate scale removal by contacting the scale with an aqueous solution consisting essentially of water, a monovalent cation salt of a monocyclic macrocyclic polyamine containing at least two nitrogen-linked carboxymethyl groups and enough monovalent basic compound to provide a solution pH of about 8. U.S. Pat. No. 4,708,805 (D'Muhala, 1987) discloses the removal of barium and strontium sulfate scales by treatment with a sequestering composition comprising citric acid, a polycarbazic acid, and an alkylenepolyaminopolycarboxylic acid, DTPA or EDTA.

### SUMMARY

A composition is provided for sulfate scale removal, said composition comprising one or more chelants and one or more accelerants, wherein said accelerants serve to occupy reactive sites of cations of the sulfate scale. The composition is preferably provided wherein said one or more chelants comprise a mixture of two or more polyaminopolycarboxylic acids. The composition if further preferably provided, wherein said one or more accelerants promote rapid complexation of cations of the sulphate scale. The composition is further still preferably provided, wherein said one or more accelerants comprise substances that have a smaller molecule size than that of said one or more chelants.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### DETAILED DESCRIPTION OF THE VARIOUS EMBODIMENT

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

In accordance with the present invention, alkaline earth scales, and more particularly sulfate scales such as barium sulfate scales can be chemically removed from surface equipment and oil and gas bearing formations by a chemical process employing a composition comprising a mixture of chelants, more preferably a mixture of polyaminopolycarboxylic acids, and accelerants to promote more rapid dissolution.

Polyaminopolycarboxylic acids of the present invention include but are not limited to ethylenediaminetetraacetic acid (EDTA), diethylenetriaminepentaacetic acid (DTPA), polyaspartic acid (PAA) and methylglycinediacetic acid (MGA) among others, and mixtures thereof

Accelerants have been found by the present inventors to be useful to promote higher rates of scale dissolution and markedly more rapid complexation of the cations of the scale deposit. Accelerants of the present invention include any number of small molecule groups that act as bridging compounds to facilitate occupying the reactive sites of the cations of the scale deposits. The accelerants of the present invention are relatively smaller molecules than the chelant materials. In this way they can fill in reactive sites on the alkaline earth scale that are otherwise not reachable by the larger chelant materials, due to steric hindrance. In this way, the accelerants of the present invention react with the alkaline earth molecules more quickly and promote more rapid access by the chelants.

Accelerants of the present invention include any smaller molecule groups, including but not limited to any member of mono or dicarboxlic acids and/or their respective salts from potassium, sodium or ammonium where the formula is:
Monocarboxylic acid: R—C(O)OH, wherein R═C2 to C6
Dicarboxylic acid: HO2C—R—CO2H, wherein R is aliphatic or aromatic ring of C2 to C6 length. More preferably, the aromatic ring is a five-member furan.

Single component and multiple component mixtures of accelerants would also be understood by those skilled in the art to be useful in the present invention.

Accelerants of the present invention preferably comprise antioxidants. More preferably, the accelerants include, but are not limited to, tocopherol, ascorbic acid, isothiocyanates, tannins such as gallic acid and polyphenols.

According to one embodiment of the present invention, scale removal can be effected with an aqueous solution of a mixture of polyaminopolycarboxylic acids such as EDTA and DTPA which act as chelating agents, together with the accelerant, to form stable complexes with the metal cations of the scale deposits.

Complexation occupies cation reactive sites of the scale deposits. Blocking the reactive sites of the cations prevents them from redepositing on surface equipment once being dissolved. The chelating agents have multiple reactive sites that serve to react with multiple cation sites and form more than one bond between the alkaline earth scale material and a molecule of the chelating agent, resulting in the formation of a ring structure incorporating the cation thereby dissolving the scale and preventing it from rescaling onto equipment surfaces.

While single component chelant solutions can be employed, the present inventors have surprisingly discovered that mixtures of more than one polyaminopolycarboxylic acids, in the form of salts of polyaminopolycarboxylic acid in solution, function more favorably to form stable complexes of the scale deposits and can sequester high concentrations of alkaline earth scales at higher rates than single component chelant solutions.

Accelerants used in the present invention can preferably be added to an aqueous solution of one or more polyaminopolycarboxylic acid salts to increase the speed of complex formation and the efficiency of scale removal. The concentration of the accelerant in the aqueous solution can preferably be at least 0.10% to 1.0% by wt. Higher concentrations of accelerant may also be used, however, no economic nor functional increase in performance is observed.

As is typical with most chelation reactions, scale removal is preferably performed under alkaline conditions ranging from a solution pH of 9-13 and most preferably at a pH of 11-12.5. It would be well understood by a person of skill in the art that alkaline conditions can be created in any suitable way known in the art for example, by the addition of any suitable alkaline components to the solution.

The preferred compositions and solutions of the present invention comprise about 1.0% to 20.0% of a mixture of various polyaminopolycarboxylic acid salts. One example of a preferred aqueous solution for scale removal is composed of the following:

| | Percentage |
|---|---|
| Ingredient | by Weight |
| Ethylenediaminetetraacetic Acid, Na⁺ or K⁺ Salt | 1-5% |
| Diethylenetriaminepentaacetic Acid, Na⁺ Salt | 3-10% |
| Polyaspartic Acid, Na⁺ or K⁺ Salt | 1-5% |
| Polyphenol | 0.1-.5% |
| Surfactant | 0.1-0.5% |

The surfactant is preferably present to reduce surface tension in the composition, but it would be well understood by a person of skill in the art that a surfactant would not be required for the compositions or methods of the present invention.

To those skilled in the art, this invention may be embodied in many different forms and it should not be construed as limited to the embodiment herein disclosed. It will be recognized to those skilled in the art that other suitable chelants and other polyaminopolycarboxylic acids and various forms of salts and various other accelerants maybe employed and interchanged for those materials herein disclosed.

The present invention may be used in downhole or surface installations. Methods of suggested application include continuous treatment down the annulus or treating string of producing wells, with water flush and continuous injection into surface lines. It can also be used for formation squeeze treatment of oil wells, which is a well-known industrial cleaning method involving using chemical compositions to protect the well downhole from scale deposition and formation damage.

An initial high dosage of the solution of the present invention of between 50-100 ppm (8-16 litres/1000 bbls of well product) based on well production rate can also be used to remove scale build-up in downhole or surface equipment and facilities, in cases of severe scaling problem. A fill and soak or circulation method of application is recommended, which is a well-known industrial chemical cleaning method involving filling up vessel or pipe system with cleaning composition and letting it soak for several hours in order to dissolve scaling. The duration of contact required for scale deposit removal will depend on the scale composition and barium sulfate content.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. Composition for sulfate scale removal, said composition comprising;
a. one or more chelants; and
b. one or more accelerants, wherein said accelerants serve to occupy reactive sites of cations of the sulfate scale.

2. The composition of claim 1 wherein said one or more chelants comprise a mixture of two or more polyaminopolycarboxylic acids.

3. The composition of claim 2, wherein said one or more polyaminopolycarboxylic acids are selected from the group consisting of ethylene diamine tetraacetic acid (EDTA), diethylene triamine pentaacetic acid (DTPA), polyaspartic acid (PAA) and methylglycine diacetic acid (MGA) and mixtures thereof.

4. The composition of claim 2, wherein said one or more accelerants promote rapid complexation of cations of the sulphate scale.

5. The composition of claim 4, wherein said one or more accelerants have a smaller molecule size than that of said one or more chelants.

6. The composition of claim 5, wherein said one or more accelerants comprise small molecule substances selected from the group consisting of monocarboxylic acids; dicarboxylic acids; potassium, sodium or ammonium salts of monocarboxylic acids; potassium, sodium or ammonium salts of dicarboxylic acids and combinations thereof.

7. The composition of claim 6, wherein the formula for the monocarboxylic acids is R—C(O)OH, wherein R═C2 to C6.

8. The composition of claim 6, wherein the formula for the dicarboxylic acids is HO2C—R—CO2H, wherein R is an aliphatic or aromatic ring of length C2 to C6.

9. The composition of claim 8 wherein said aromatic is a five-member furan.

10. The composition of claim 5, wherein said one or more accelerants comprise small molecule antioxidants.

11. The composition of claim 10, wherein said accelerants are selected from the group consisting of tocopherol, ascorbic acid, isothiocyanates, tannins and polyphenols.

12. The composition of claim 11, wherein the tannins comprise gallic acid.

13. The composition of claim 3, wherein said one or more polyaminopolycarboxylic acids comprise a mixture of EDTA and DTPA.

14. The composition of claim 11, wherein the concentration of the accelerant in the composition is between 0.10 wt. % to 1.0 wt. %.

15. The composition of claim 14, wherein the concentration of the one or more polyaminopolycarboxylic acids in the composition is between 1.0 wt. % to 20.0 wt. %.

16. The composition of claim 15, wherein the one or more polyaminopolycarboxylic acids are present in the form of acid salts in solution.

17. The composition of claim 15, further comprising one or more surfactants.

18. The composition of claim 15, wherein said composition is applied under alkaline conditions.

19. The composition of claim 18, wherein said alkaline conditions comprise maintaining the composition at a pH of from 9 to 13.

20. The composition of claim 19, wherein said alkaline conditions comprise maintaining the composition at a pH of from 11 to 12.5.

21. The composition of claim 1, for use in continuous treatment down producing wells, with water flush and continuous injection into surface lines.

22. The composition of claim 1, for use in formation squeeze treatment of oil wells.

23. The composition of claim 1, for us in an aqueous solution at a concentration of from 50 to 100 ppm.

24. The composition of claim 1, for use in a fill and soak or circulation method of application.
